(19) United States
(12) Patent Application Publication
(10) Pub. No.: US 2023/0023102 A1
(43) Pub. Date: Jan. 26, 2023

(54) APPARATUS, METHOD, AND COMPUTER PROGRAM FOR PROVIDING LIP-SYNC VIDEO AND APPARATUS, METHOD, AND COMPUTER PROGRAM FOR DISPLAYING LIP-SYNC VIDEO

(71) Applicant: MINDS LAB INC., Daejeon (KR)

(72) Inventors: Hyoung Kyu SONG, Seoul (KR); Dong Ho CHOI, Gyeonggi-do (KR); Hong Seop CHOI, Gyeonggi-do (KR)

(73) Assignee: MINDS LAB INC., Daejeon (KR)

(21) Appl. No.: 17/560,434

(22) Filed: Dec. 23, 2021

Related U.S. Application Data
(63) Continuation of application No. PCT/KR2021/016167, filed on Nov. 8, 2021.

(30) Foreign Application Priority Data
Jul. 22, 2021 (KR) 10-2021-0096721

(51) Int. Cl. G10L 13/08; G06N 3/08; G06T 7/73; G10L 13/027

(52) U.S. Cl. CPC G10L 13/08; G06N 3/08; G06T 7/73; G10L 13/027; G06T 2207/30201; G06T 2207/20081; G06T 2207/20084

(57) ABSTRACT

Provided is a lip-sync video providing apparatus for providing a video in which a voice and lip shapes are synchronized. The lip-sync video providing apparatus is configured to obtain a template video including at least one frame and depicting a target object, obtain a target voice to be used as a voice of the target object, generate a lip image corresponding to the voice for each frame of the template video by using a trained first artificial neural network, and generate lip-sync data including frame identification information of a frame in the template video, the lip image, and position information regarding the lip image in a frame in the template video.

### CROSS-REFERENCE OF RELATED APPLICATIONS AND PRIORITY

The present application is a continuation of International Patent Application No. PCT/KR2021/016167, filed on Nov. 8, 2021, which claims priority to Korean Patent Application No. 10-2021-0096721, filed on Jul. 22, 2021, the disclosure of which are incorporated by reference as if they are fully set forth herein.

### TECHNICAL FIELD

The present disclosure relates to an apparatus, a method, and a computer program for providing a lip-sync videos in which a voice is synchronized with lip shapes, and more particularly, to an apparatus, a method, and a computer program for displaying a lip-sync video in which a voice is synchronized with lip shapes.

### BACKGROUND

With the development of information and communication technology, artificial intelligence technology is being introduced into many applications. Conventionally, in order to generate a video in which a specific person speaks about a specific topic, only a method of obtaining a video of the person actually speaking about the topic with a camera or the like was the only option.

Also, in some prior art, a synthesized video based on an image or a video of a specific person was generated by using an image synthesis technique, but such a video still has a problem in that the shape of the person's mouth is unnatural.

### SUMMARY

The present disclosure provides generation of a more natural video.

In particular, the present disclosure provides generation of a video with natural lip shapes without filming a real person.

The present disclosure also provides minimization of the use of server resources and network resources used in image generation despite the use of artificial neural networks.

According to an aspect of the present disclosure, a lip-sync video providing apparatus for providing a video in which a voice and lip shapes are synchronized, wherein the lip-sync video providing apparatus is configured to obtain a template video including at least one frame and depicting a target object, obtain a target voice to be used as a voice of the target object, generate a lip image corresponding to the voice for each frame of the template video by using a trained first artificial neural network, and generate lip-sync data including frame identification information of a frame in the template video, the lip image, and position information regarding the lip image in a frame in the template video.

The lip-sync video providing apparatus may transmit the lip-sync data to a user terminal.

The user terminal may read a frame corresponding to the frame identification information from a memory with reference to the frame identification information, and based on the position information regarding the lip image, generate an output frame by overlapping the lip image on a read frame.

The lip-sync video providing apparatus may generate the lip-sync data for each frame of the template video, and the user terminal may receive the lip-sync data generated for each frame and generates an output frame for each of the lip-sync data.

Before transmitting the lip-sync data to the user terminal, the lip-sync video providing apparatus may transmit at least one of identification information of the template video, the template video, and the voice to the user terminal.

The first artificial neural network may be an artificial neural network trained to output a second lip image, which is generated by modifying the first lip image according to a voice, as the voice and the first lip image are input.

The lip-sync video providing apparatus may generate the target voice from a text by using a trained second artificial neural network, and the second artificial neural network may be an artificial neural network trained to output a voice corresponding to an input text as a text is input.

According to another aspect of the present disclosure, a lip-sync video providing apparatus for displaying a video in which a voice and lip shapes are synchronized, wherein the lip-sync video displaying apparatus is configured to receive a template video and a target voice to be used as a voice of a target object from a server, receive lip-sync data generated for each frame, wherein the lip-sync data includes frame identification information of a frame in the template video, a lip image, and position information regarding the lip image in a frame in the template video, and display a lip-sync video by using the template video, the target voice, and the lip-sync data.

The lip-sync video displaying apparatus may read a frame corresponding to the frame identification information from a memory with reference to the frame identification information included in the lip-sync data, generate an output frame by overlapping the lip image included in the lip-sync data on a read frame based on the position information regarding the lip image included in the lip-sync data, and display a generated output frame.

The lip-sync video displaying apparatus may receive a plurality of lip-sync data according to a flow of the target voice, and sequentially display output frames respectively generated from the plurality of lip-sync data according to the lapse of time.

According to another aspect of the present disclosure, a lip-sync video providing method for providing a video in which a voice and lip shapes are synchronized, the lip-sync video providing method comprises obtaining a template video including at least one frame and depicting a target object; obtaining a target voice to be used as a voice of the target object; generating a lip image corresponding to the voice for each frame of the template video by using a trained first artificial neural network; and generating lip-sync data including frame identification information of a frame in the template video, the lip image, and position information regarding the lip image in a frame in the template video.

The lip-sync video providing method may further include, after the generating of the lip-sync data, transmitting the lip-sync data to a user terminal.

The user terminal may read a frame corresponding to the frame identification information from a memory with reference to the frame identification information, and based on the position information regarding the lip image, generate an output frame by overlapping the lip image on a read frame.

The lip-sync video providing method may generate the lip-sync data for each frame of the template video, and the user terminal may receive the lip-sync data generated for each frame and generates an output frame for each of the lip-sync data.

The lip-sync video providing method may further include, before the transmitting of the lip-sync data to the user terminal, transmitting at least one of identification information of the template video, the template video, and the voice to the user terminal.

The first artificial neural network may be an artificial neural network trained to output a second lip image, which is generated by modifying the first lip image according to a voice, as the voice and the first lip image are input.

The lip-sync video providing method may further include generating the target voice from a text by using a trained second artificial neural network, wherein the second artificial neural network may be an artificial neural network trained to output a voice corresponding to an input text as a text is input.

According to another aspect of the present disclosure, a lip-sync video providing method for displaying a video in which a voice and lip shapes are synchronized, wherein the lip-sync video providing method includes receiving a template video and a target voice to be used as a voice of a target object from a server, receiving lip-sync data generated for each frame, wherein the lip-sync data includes frame identification information of a frame in the template video, a lip image, and position information regarding the lip image in a frame in the template video, and displaying a lip-sync video by using the template video, the target voice, and the lip-sync data.

The displaying of the lip-sync video may include reading a frame corresponding to the frame identification information from a memory with reference to the frame identification information included in the lip-sync data; generating an output frame by overlapping the lip image included in the lip-sync data on a read frame based on the position information regarding the lip image included in the lip-sync data; and displaying a generated output frame.

The lip-sync video displaying method may receive a plurality of lip-sync data according to a flow of the target voice, and sequentially display output frames respectively generated from the plurality of lip-sync data according to the lapse of time.

According to one or more embodiments of the present disclosure, a lip-sync video providing apparatus includes a server and a service server. The server includes a first processor, a memory, a second processor, and a communication unit. The server is configured to: (i) obtain a template video comprising at least one frame and depicting a target object, (ii) obtain a target voice to be used as a voice of the target object, (iii) generate a lip image corresponding to the voice for each frame of the template video by using a trained first artificial neural network, and (iv) generate lip-sync data comprising frame identification information of a frame in the template video, the lip image, and position information regarding the lip image in a frame in the template video. The first processor is configured to control a series of processes of generating output data from input data by using the trained first artificial neural network. The second processor is configured to perform an operation under the control of the first processor. The service server is in communication with the server and operable to receive the lip-sync data including the generated lip images from the server, generate output frames by using the lip-sync data, and provide the output frames to another device including the user terminal. The communication unit includes hardware and software that enable the server to communicate with a user terminal and a service server, via a communication network.

In at least one variant, the user terminal is operable to receive the lip-sync data.

In another variant, the user terminal is further configured to read a frame corresponding to the frame identification information from a memory with reference to the frame identification information, and based on the position information regarding the lip image, generate an output frame by overlapping the lip image on a read frame.

In another variant, the server is further configured to generate the lip-sync data for each frame of the template video. The user terminal is further configured to receive the lip-sync data generated for each frame and generates an output frame for each of the lip-sync data.

Before transmitting the lip-sync data to the user terminal, the server is further operable to transmit at least one of identification information of the template video, the template video, and the voice to the user terminal.

In another variant, the first artificial neural network comprises an artificial neural network trained to output a second lip image. The second lip image generated based on modification of the first lip image according to a voice, as the voice and the first lip image are input.

In another variant, the server is further configured to generate the target voice from a text by using a trained second artificial neural network. The second artificial neural network is an artificial neural network trained to output a voice corresponding to an input text as a text is input.

According to one or more embodiments of the present disclosure, a lip-sync video providing apparatus includes a server and a service server. The server includes at least one processor, a memory coupled to the at least one processor, and a communication unit coupled to the at least one processor. The server is configured to receive a template video and a target voice to be used as a voice of a target object from a server, receive lip-sync data generated for each frame, wherein the lip-sync data comprises frame identification information of a frame in the template video, a lip image, and position information regarding the lip image in a frame in the template video, and display a lip-sync video by using the template video, the target voice, and the lip-sync data. The communication unit includes hardware and software that enable the server to communicate with a user terminal, a service server, via a communication network. The service server is in communication with the server and operable to receive the lip-sync data including the generated lip images from the server, generate output frames by using the lip-sync data, and provide the output frames to another device including the user terminal.

In at least one variant, the server is further configured to read a frame corresponding to the frame identification information from a memory with reference to the frame identification information included in the lip-sync data, generate an output frame by overlapping the lip image included in the lip-sync data on a read frame based on the position information regarding the lip image included in the lip-sync data, and display a generated output frame.

In another variant, the server is further configured to receive a plurality of lip-sync data according to a flow of the target voice, and sequentially display output frames respectively generated from the plurality of lip-sync data according to the lapse of time.

According to one or more embodiments of the present disclosure, a lip-sync video providing method includes steps of (i) obtaining a template video comprising at least one frame and depicting a target object, (ii) obtaining a target voice to be used as a voice of the target object, (iii) generating a lip image corresponding to the target voice for each frame of the template video by using a trained first artificial neural network, (iv) generating lip-sync data comprising frame identification information of a frame in the template video, the lip image, and position information regarding the lip image in a frame in the template video, and (v) providing a video in which a voice and lip shapes are synchronized.

In at least one variant, the lip-sync video providing method further includes transmitting the lip-sync data to a user terminal.

In another variant, the lip-sync video providing method further includes, at the user terminal, reading a frame corresponding to the frame identification information from a memory with reference to the frame identification information, and based on the position information regarding the lip image, generating an output frame by overlapping the lip image on a read frame.

In another variant, the lip-sync video providing method further includes generating the lip-sync data for each frame of the template video, at the user terminal, receiving the lip-sync data generated for each frame, and generating an output frame for each of the lip-sync data.

In another variant, before transmitting the lip-sync data to the user terminal, the lip-sync video providing method further includes transmitting at least one of identification information of the template video, the template video, and the voice to the user terminal.

In another variant, the first artificial neural network is an artificial neural network trained to output a second lip image, which is generated by modifying the first lip image according to a voice, as the voice and the first lip image are input.

In another variant, the lip-sync video providing method further includes generating the target voice from a text by using a trained second artificial neural network. The second artificial neural network is an artificial neural network trained to output a voice corresponding to an input text as a text is input.

According to the present disclosure, a more natural video of a person may be generated.

In particular, according to the present disclosure, a video with natural lip shapes may be generated without filming a real person.

Also, according to the present disclosure, the use of server resources and network resources used in image generation may be minimized despite the use of artificial neural networks.

### BRIEF DESCRIPTION OF DRAWINGS

FIG. 1 is a diagram schematically showing the configuration of a lip-sync video generating system according to an embodiment of the present disclosure.

FIG. 2 is a diagram schematically showing a configuration of a server according to an embodiment of the present disclosure.

FIG. 3 is a diagram schematically showing a configuration of a service server according to an embodiment of the present disclosure.

FIGS. 4 and 5 are diagrams for describing example structures of an artificial neural network trained by a server according to an embodiment of the present disclosure, where:

FIG. 4 illustrates a convolutional neural network (CNN) model; and

FIG. 5 illustrates a recurrent neural network (RNN) model.

FIG. 6 is a diagram for describing a method by which a server trains a first artificial neural network by using a plurality of pieces of training data according to an embodiment of the present disclosure.

FIG. 7 is a diagram for describing a process in which a server outputs a lip image by using a trained first artificial neural network according to an embodiment of the present disclosure.

FIG. 8 is a diagram for describing a method by which a server trains a second artificial neural network by using a plurality of pieces of training data according to an embodiment of the present disclosure.

FIG. 9 is a diagram for describing a process in which a server outputs a target voice by using a second artificial neural network according to an embodiment of the present disclosure.

FIGS. 10 and 11 are flowcharts of a method performed by a server to provide a lip-sync video and a method performed by a user terminal to display a provided lip-sync video, according to an embodiment of the present disclosure, where:

FIG. 10 illustrates that a server and a user terminal process a first frame; and

FIG. 11 illustrates that the server and the user terminal process a second frame.

FIG. 12 is a diagram for describing a method by which a user terminal generates output frames according to an embodiment of the present disclosure.

### DETAILED DESCRIPTION

According to an aspect of the present disclosure, a lip-sync video providing apparatus for providing a video in which a voice and lip shapes are synchronized, wherein the lip-sync video providing apparatus is configured to obtain a template video including at least one frame and depicting a target object, obtain a target voice to be used as a voice of the target object, generate a lip image corresponding to the voice for each frame of the template video by using a trained first artificial neural network, and generate lip-sync data including frame identification information of a frame in the template video, the lip image, and position information regarding the lip image in a frame in the template video.

The present disclosure may include various embodiments and modifications, and embodiments thereof will be illustrated in the drawings and will be described herein in detail. The effects and features of the present disclosure and the accompanying methods thereof will become apparent from the following description of the embodiments, taken in conjunction with the accompanying drawings. However, the present disclosure is not limited to the embodiments described below, and may be embodied in various modes.

Reference will now be made in detail to embodiments, examples of which are illustrated in the accompanying drawings. In the drawings, the same elements are denoted by the same reference numerals, and a repeated explanation thereof will not be given.

It will be understood that although the terms “first”, “second”, etc. may be used herein to describe various elements, these elements should not be limited by these terms. These elements are only used to distinguish one element from another. As used herein, the singular forms “a,” “an” and “the” are intended to include the plural forms as well, unless the context clearly indicates otherwise. It will be further understood that the terms “comprises” and/or “comprising” used herein specify the presence of stated features or components, but do not preclude the presence or addition of one or more other features or components. Sizes of elements in the drawings may be exaggerated for convenience of explanation. In other words, since sizes and shapes of components in the drawings are arbitrarily illustrated for convenience of explanation, the following embodiments are not limited thereto.

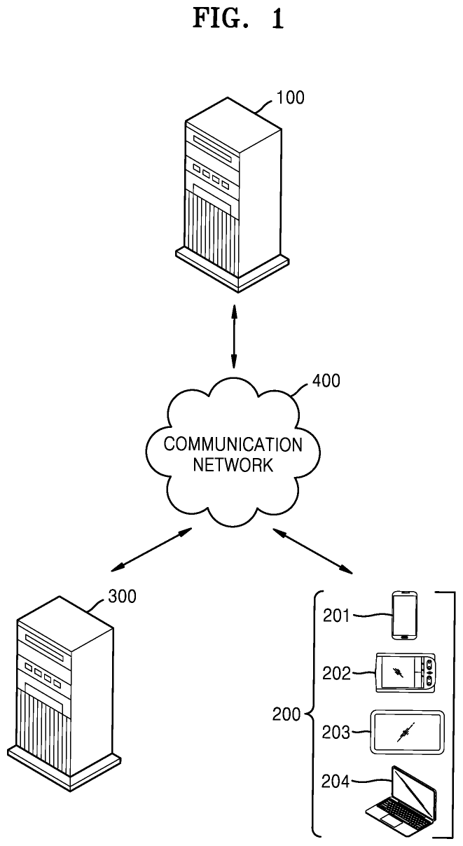

FIG. 1 is a diagram schematically showing the configuration of a lip-sync video generating system according to an embodiment of the present disclosure.

A lip-sync video generating system according to an embodiment of the present disclosure may display lip images (generated by a server) on a video receiving device (e.g., a user terminal) to overlap a template frame (stored in a memory of the video receiving device) including a face.

At this time, the server of the lip-sync image generating system may generate sequential lip images from a voice to be used as a voice of a target object, and the video receiving device may overlap the sequential lip images and a template image to display a video in which the sequential lip image match the voice.

As described above, according to the present disclosure, when generating a lip-sync video, some operations are performed by the video receiving device. Therefore, resources of a server may be used more efficiently, and related resources may also be used more efficiently.

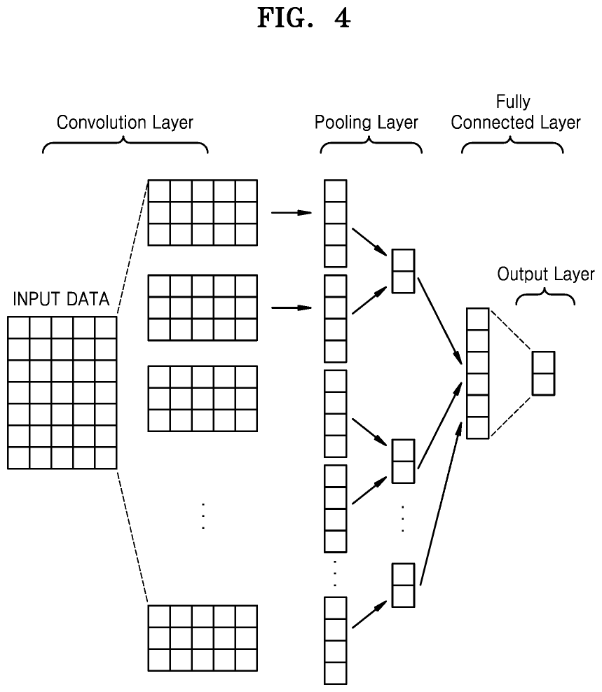

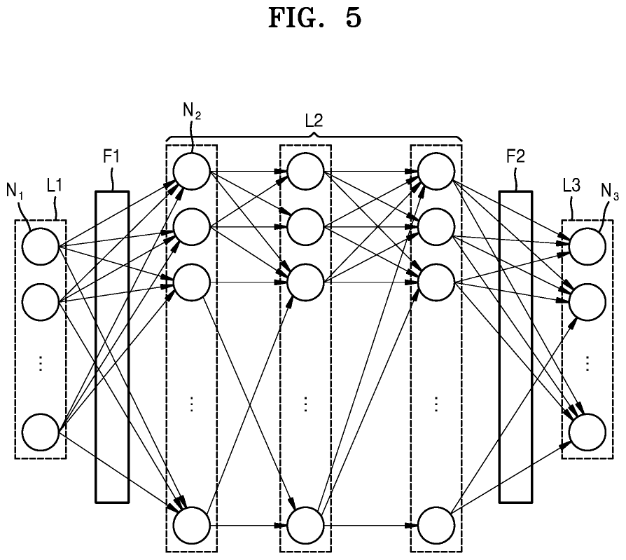

In the present disclosure, an ‘artificial neural network’, such as a first artificial neural network and a second artificial neural network, is a neural network trained by using training data according to a purpose thereof and may refer to an artificial neural network trained by using a machine learning technique or a deep learning technique. The structure of such an artificial neural network will be described later with reference to FIGS. 4 to 5.

A lip-sync video generating system according to an embodiment of the present disclosure may include a server 100, a user terminal 200, a service server 300, and a communication network 400 as shown in FIG. 1.

The server 100 according to an embodiment of the present disclosure may generate lip images from a voice by using a trained first artificial neural network and provide generated lip images to the user terminal 200 and/or the service server 300.

At this time, the server 100 may generate a lip image corresponding to the voice for each frame of a template video and generate lip-sync data including identification information regarding frames in the template video, generated lip images, and information of positions of the lip images in template frames. Also, the server 100 may provide generated lip-sync data to the user terminal 200 and/or the service server 300. In the present disclosure, the server 100 as described above may sometimes be referred to as a ‘lip-sync video providing apparatus’.

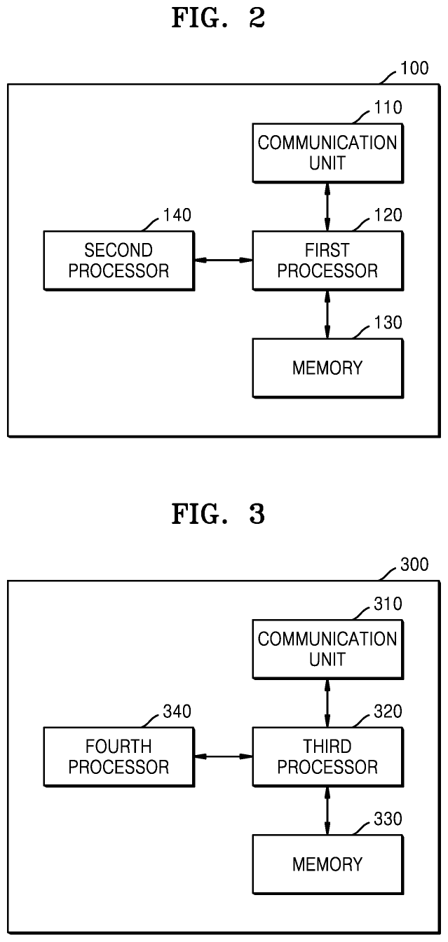

FIG. 2 is a diagram schematically showing a configuration of the server 100 according to an embodiment of the present disclosure. Referring to FIG. 2, the server 100 according to an embodiment of the present disclosure may include a communication unit 110, a first processor 120, a memory 130, and a second processor 140. Also, although not shown, the server 100 according to an embodiment of the present disclosure may further include an input/output unit, a program storage unit, etc.

The communication unit 110 may be a device including hardware and software necessary for the server 100 to transmit and receive signals like control signals or data signals through a wire or a wireless connection with other network devices like the user terminal 200 and/or the service server 300.

The first processor 120 may be a device that controls a series of processes of generating output data from input data by using trained artificial neural networks. For example, the first processor 120 may be a device for controlling a process of generating lip images corresponding to an obtained voice by using the trained first artificial neural network.

In this case, the processor may refer to, for example, a data processing device embedded in hardware and having a physically structured circuit to perform a function expressed as a code or an instruction included in a program. As examples of such a data processing device embedded in hardware may include processing devices like a microprocessor, a central processing unit (CPU), a processor core, a multiprocessor, an application-specific integrated circuit (ASIC), and a field programmable gate array (FPGA), but the technical scope of the present disclosure is not limited thereto.

The memory 130 performs a function of temporarily or permanently storing data processed by the server 100. The memory 130 may include a magnetic storage medium or a flash storage medium, but the scope of the present disclosure is not limited thereto. For example, the memory 130 may temporarily and/or permanently store data (e.g., coefficients) constituting a trained artificial neural network. Of course, the memory 130 may store training data for training an artificial neural network or data received from the service server 300. However, these are merely examples, and the spirit of the present disclosure is not limited thereto.

The second processor 140 may refer to a device that performs an operation under the control of the above-stated first processor 120. In this case, the second processor 140 may be a device having a higher arithmetic performance than the above-stated first processor 120. For example, the second processor 140 may include a graphics processing unit (GPU). However, this is merely an example, and the spirit of the present disclosure is not limited thereto. According to an embodiment of the present disclosure, the second processor 140 may be a single processor or a plurality of processors.

In an embodiment of the present disclosure, the service server 300 may be a device that receives lip-sync data including generated lip images from the server 100, generates output frames by using the lip-sync data, and provide the output frames to another device (e.g., the user terminal 200).

In another embodiment of the present disclosure, the service server 300 may be a device that receives an artificial neural network trained by the server 100 and provides lip-sync data in response to a request from another device (e.g., the user terminal 200).

FIG. 3 is a diagram schematically showing a configuration of the service server 300 according to an embodiment of the present disclosure. Referring to FIG. 3, the service server 300 according to an embodiment of the present disclosure may include a communication unit 310, a third processor 320, a memory 330, and a fourth processor 340. Also, although not shown, the service server 300 according to an embodiment of the present disclosure may further include an input/output unit, a program storage unit, etc.

In an embodiment of the present disclosure, the third processor 320 may be a device that controls a process for receiving lip-sync data including generated lip images from the server 100, generating output frames by using the lip-sync data, and providing the output frames to another device (e.g., the user terminal 200).

Meanwhile, in another embodiment of the present disclosure, the third processor 320 may be a device that provides lip-sync data in response to a request of another device (e.g., the user terminal 200) by using a trained artificial neural network (received from the server 100).

In this case, the processor may refer to, for example, a data processing device embedded in hardware and having a physically structured circuit to perform a function expressed as a code or an instruction included in a program. As examples of such a data processing device embedded in hardware may include processing devices like a microprocessor, a central processing unit (CPU), a processor core, a multiprocessor, an application-specific integrated circuit (ASIC), and a field programmable gate array (FPGA), but the technical scope of the present disclosure is not limited thereto.

The memory 330 performs a function of temporarily or permanently storing data processed by the service server 300. The memory 130 may include a magnetic storage medium or a flash storage medium, but the scope of the present disclosure is not limited thereto. For example, the memory 330 may temporarily and/or permanently store data (e.g., coefficients) constituting a trained artificial neural network. Of course, the memory 330 may store training data for training an artificial neural network or data received from the service server 300. However, these are merely examples, and the spirit of the present disclosure is not limited thereto.

The fourth processor 340 may refer to a device that performs an operation under the control of the above-stated third processor 320. In this case, the fourth processor 340 may be a device having a higher arithmetic performance than the above-stated third processor 320. For example, the fourth processor 340 may include a graphics processing unit (GPU). However, these are merely examples, and the spirit of the present disclosure is not limited thereto. According to an embodiment of the present disclosure, the fourth processor 340 may be a single processor or a plurality of processors.

The user terminal 200 according to an embodiment of the present disclosure may refer to various types of devices that intervene between a user and the server 100, such that the user may use various services provided by the server 100. In other words, the user terminal 200 according to an embodiment of the present disclosure may refer to various devices for transmitting and receiving data to and from the server 100.

The user terminal 200 according to an embodiment of the present disclosure may receive lip-sync data provided by the server 100 and generate output frames by using the lip-sync data. As shown in FIG. 1, the user terminal 200 may refer to portable terminals 201, 202, and 203 or a computer 204.

The user terminal 200 according to an embodiment of the present disclosure may include a display unit for displaying contents to perform the above-described function and an input unit for obtaining user inputs regarding the contents. In this case, the input unit and the display unit may be configured in various ways. For example, the input unit may include, but is not limited to, a keyboard, a mouse, a trackball, a microphone, a button, and a touch panel.

In the present disclosure, the user terminal 200 as described above may sometimes be referred to as a ‘lip-sync video displaying apparatus’.

The communication network 400 according to an embodiment of the present disclosure may refer to a communication network that mediates transmission and reception of data between components of the lip-sync video generating system. For example, the communication network 400 may include wired networks like local area networks (LANs), wide area networks (WANs), metropolitan area networks (MANs), and integrated service digital networks (ISDNs) or wireless networks like wireless LANs, CDMA, Bluetooth, and satellite communication, but the scope of the present disclosure is not limited thereto.

FIGS. 4 and 5 are diagrams for describing example structures of an artificial neural network trained by the server 100 according to an embodiment of the present disclosure. Hereinafter, for convenience of explanation, a first artificial neural network and a second artificial neural network will be collectively referred to as an ‘artificial neural network’.

An artificial neural network according to an embodiment of the present disclosure may be an artificial neural network according to a convolutional neural network (CNN) model as shown in FIG. 4. In this case, the CNN model may be a layer model used to ultimately extract features of input data by alternately performing a plurality of computational layers including a convolutional layer and a pooling layer.

The server 100 according to an embodiment of the present disclosure may construct or train an artificial neural network model by processing training data according to a supervised learning technique. A method by which the server 100 trains an artificial neural network will be described later in detail.

The server 100 according to an embodiment of the present disclosure may use a plurality of pieces of training data to train an artificial neural network by repeatedly performing a process of updating a weight of each layer and/or each node, such that an output value generated by inputting any one input data to the artificial neural network is close to a value indicated by corresponding training data.

In this case, the server 100 according to an embodiment of the present disclosure may update a weight (or a coefficient) of each layer and/or each node according to a back propagation algorithm.

The server 100 according to an embodiment of the present disclosure may generate a convolution layer for extracting feature values of input data and a pooling layer that generates a feature map by combining extracted feature values.

Also, the server 100 according to an embodiment of the present disclosure may combine generated feature maps, thereby generating a fully connected layer that prepares to determine the probability that input data corresponds to each of a plurality of items.

The server 100 according to an embodiment of the present disclosure may calculate an output layer including an output corresponding to input data.

Although the example shown in FIG. 4 shows that input data is divided into 5×7 blocks, 5×3 unit blocks are used to generate a convolution layer and 1×4 or 1×2 unit blocks are used to generate a pooling layer, it is merely an example, and the technical spirit of the present disclosure is not limited thereto. Therefore, the type of input data and/or the size of each block may be variously configured.

Meanwhile, such an artificial neural network may be stored in the above-stated memory 130, in the form of coefficients of a function defining the model type of the artificial neural network, coefficients of at least one node constituting the artificial neural network, weights of nodes, and a relationship between a plurality of layers constituting the artificial neural network. Of course, the structure of an artificial neural network may also be stored in the memory 130 in the form of source codes and/or a program.

An artificial neural network according to an embodiment of the present disclosure may be an artificial neural network according to a recurrent neural network (RNN) model as shown in FIG. 5.

Referring to FIG. 5, the artificial neural network according to the RNN model may include an input layer L1 including at least one input node N1, a hidden layer L2 including a plurality of hidden nodes N2, and an output layer L3 including at least one output node N3.

The hidden layer L2 may include one or more fully connected layers as shown in FIG. 5. When the hidden layer L2 includes a plurality of layers, the artificial neural network may include a function (not shown) defining a relationship between hidden layers L2.

The at least one output node N3 of the output layer L3 may include an output value generated from an input value of the input layer L1 by the artificial neural network under the control of the server 100.

Meanwhile, a value included in each node of each layer may be a vector. Also, each node may include a weight corresponding to the importance of the corresponding node.

Meanwhile, the artificial neural network may include a first function F1 defining a relationship between the input layer L1 and the hidden layer L2 and a second function F2 defining a relationship between the hidden layer L2 and the output layer L3.

The first function F1 may define a connection relationship between the input node N1 included in the input layer L1 and the hidden nodes N2 included in the hidden layer L2. Similarly, the second function F2 may define a connection relationship between the hidden nodes N2 included in the hidden layer L2 and the output node N3 included in the output layer L3.

The first function F1, the second function F2, and functions between hidden layers may include a RNN model that outputs a result based on an input of a previous node.

In the process of training the artificial neural network by the server 100, the first function F1 and the second function F2 may be learned based on a plurality of training data. Of course, in the process of training the artificial neural network, functions between a plurality of hidden layers may also be learned in addition to the first function F1 and second function F2.

An artificial neural network according to an embodiment of the present disclosure may be trained according to a supervised learning method based on labeled training data.

The server 100 according to an embodiment of the present disclosure may use a plurality of pieces of training data to train an artificial neural network by repeatedly performing a process of updating the above-stated functions (F1, F2, the functions between hidden layers, etc.), such that an output value generated by inputting any one input data to the artificial neural network is close to a value indicated by corresponding training data.

In this case, the server 100 according to an embodiment of the present disclosure may update the above-stated functions (F1, F2, the functions between the hidden layers, etc.) according to a back propagation algorithm. However, this is merely an example, and the spirit of the present disclosure is not limited thereto.

The types and/or the structures of the artificial neural networks described in FIGS. 4 and 5 are merely examples, and the spirit of the present disclosure is not limited thereto. Therefore, artificial neural networks of various types of models may correspond to the ‘artificial neural networks’ described throughout the specification.

Hereinafter, a method of providing a lip-sync video performed by the server 100 and a method of displaying a lip-sync video performed by the user terminal 200 will be mainly described.

The server 100 according to an embodiment of the present disclosure may train a first artificial neural network and a second artificial neural network by using respective training data.

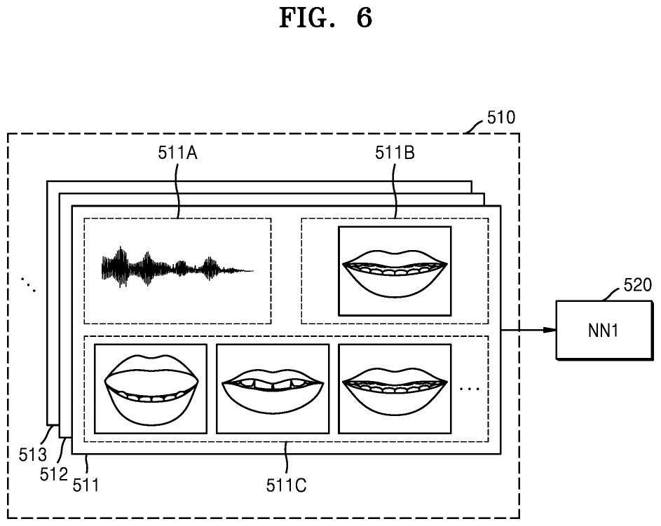

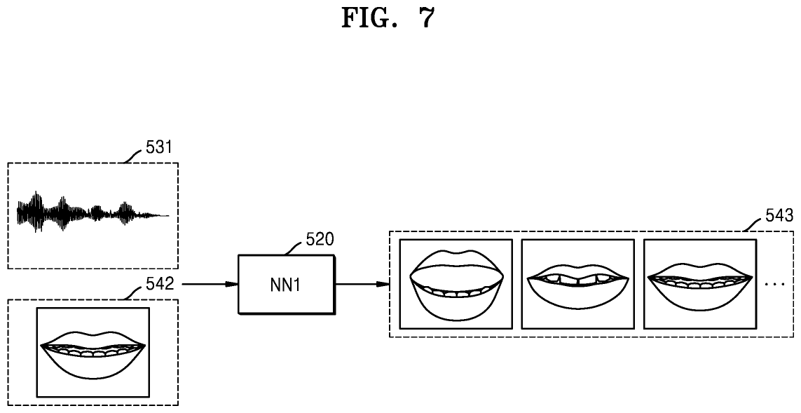

FIG. 6 is a diagram for describing a method by which the server 100 trains a first artificial neural network 520 by using a plurality of pieces of training data 510 according to an embodiment of the present disclosure. FIG. 7 is a diagram for describing a process in which the server 100 outputs a lip image 543 by using the trained first artificial neural network 520 according to an embodiment of the present disclosure.

The first artificial neural network 520 according to an embodiment of the present disclosure may refer to a neural network that is trained (or learns) correlations between a first lip image, a voice, and a second lip image included in each of the plurality of pieces of training data 510.

Therefore, as shown in FIG. 7, the first artificial neural network 520 according to an embodiment of the present disclosure may refer to an artificial neural network that is trained (or learns) to output a second lip image 543, which is a an image generated by modifying the first lip image 542 according to the voice 531, as the voice 531 and the first lip image 542 are input. In this case, the first lip image 542 may be a sample image including the shape of lips, which is the basis for generating a lip image according to a voice.

Each of the plurality of pieces of training data 510 according to an embodiment of the present disclosure may include a first lip image, a voice, and a second lip image.

For example, first training data 511 may include a first lip image 511B, a voice 511A, and a second lip image 511C. Similarly, second training data 512 and third training data 513 may each include a first lip image, a voice, and a second lip image.

Meanwhile, in an embodiment of the present disclosure, a second lip image included in each of the plurality of training data 510 may be a single second lip image or a plurality of second lip images. For example, in an example in which the server 100 divides a voice according to a certain rule and generates lip images from a divided voice section, a single second lip image may be generated from each voice section. In this case, a voice included in each of the plurality of training data 510 may also correspond to a section divided from an entire voice.

Meanwhile, in an example in which the server 100 generates a series of lip images from an entire voice, a plurality of second lip images may be generated from the entire voice as shown in FIG. 6. However, this is merely an example, and the spirit of the present disclosure is not limited thereto.

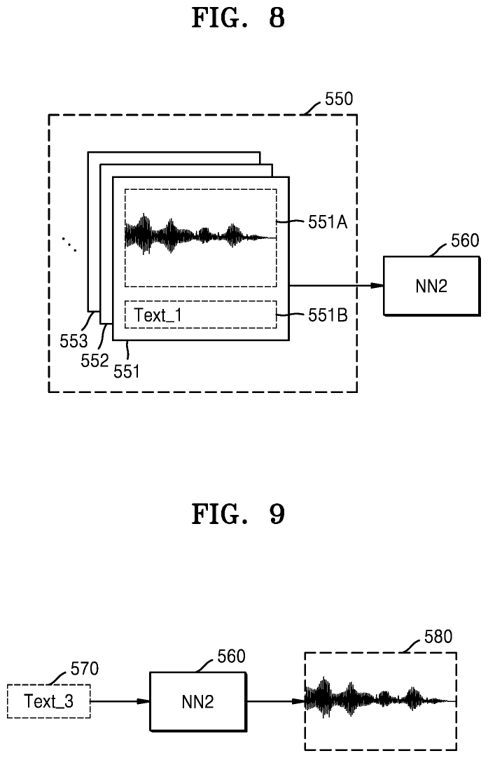

FIG. 8 is a diagram for describing a method by which the server 100 trains a second artificial neural network 560 by using a plurality of pieces of training data 550 according to an embodiment of the present disclosure. FIG. 9 is a diagram for describing a process in which the server 100 generates a target voice 580 by using the second artificial neural network 560 according to an embodiment of the present disclosure.

The second artificial neural network 560 according to an embodiment of the present disclosure may refer to a neural network that is trained (or learns) correlations between a text included in each of the plurality of training data 550 and a target voice corresponding to a reading sound of the corresponding voice.

Therefore, as shown in FIG. 9, the second artificial neural network 560 according to an embodiment of the present disclosure may refer to an artificial neural network that is trained (or learns) to output the target voice 580 corresponding to a text 570 as the text 570 is input.

In this case, each of the plurality of training data 550 may include a text and a target voice corresponding to a reading sound of the corresponding text.

For example, the first training data 551 may include a target voice 551A and a text 551B corresponding thereto. Similarly, second training data 552 and third training data 553 may each include a target voice and a text corresponding to the target voice.

Hereinafter, it will be described on the assumption that the first artificial neural network 520 and the second artificial neural network 560 have been trained according to the processes described above with reference to FIGS. 6 to 9.

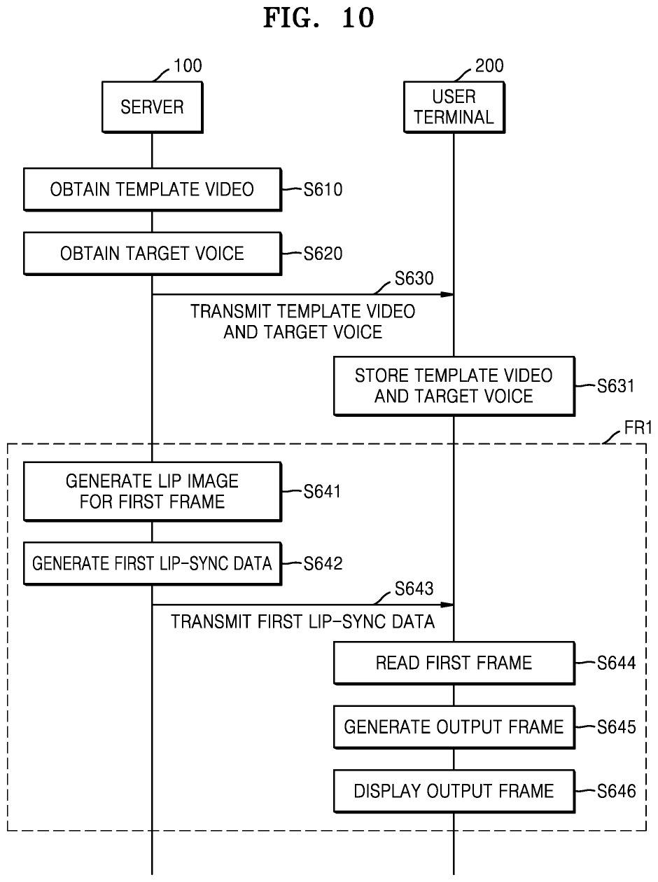

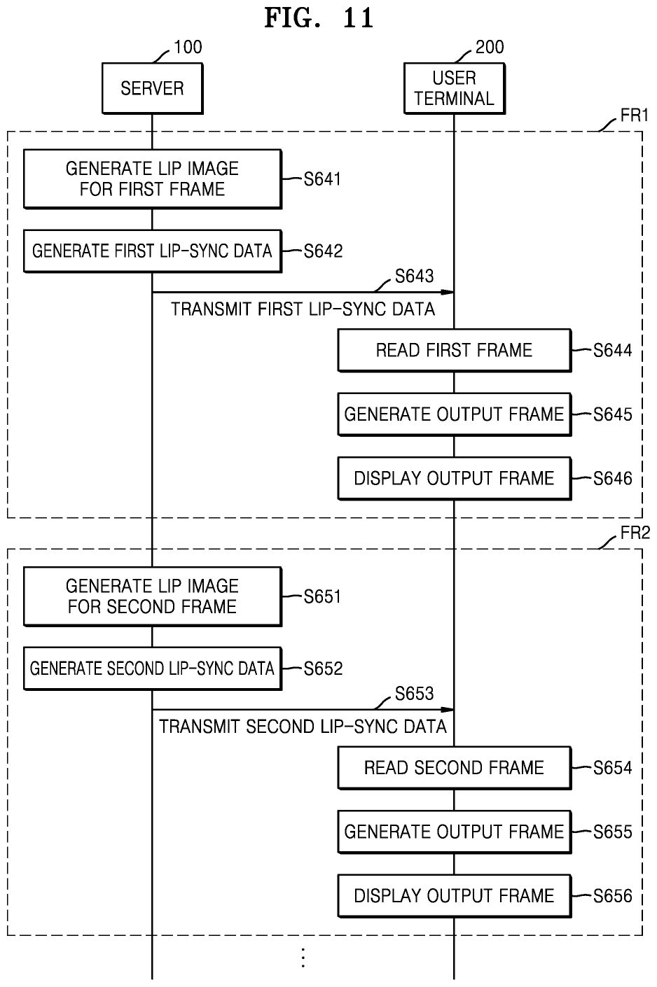

FIGS. 10 and 11 are flowcharts of a method performed by the server 100 to provide a lip-sync video and a method performed by the user terminal 200 to display a provided lip-sync video, according to an embodiment of the present disclosure.

The server 100 according to an embodiment of the present disclosure may obtain a template video including of at least one frame and depicting a target object (operation S610).

In the present disclosure, a ‘template video’ is a video depicting a target object and may be a video including a face of the target object. For example, a template video may be a video including the upper body of a target object or a video including the entire body of the target object.

Meanwhile, as described above, a template video may include a plurality of frames. For example, a template frame may be a video having a length of several seconds and including of 30 frames per second. However, this is merely an example, and the spirit of the present disclosure is not limited thereto.

The server 100 according to an embodiment of the present disclosure may obtain a template video by receiving a template video from another device or by loading a stored template video. For example, the server 100 may obtain a template video by loading the template video from the memory 130. However, this is merely an example, and the spirit of the present disclosure is not limited thereto.

The server 100 according to an embodiment of the present disclosure may obtain a target voice to be used as the voice of a target object (operation S620).

In the present disclosure, a ‘target voice’ is used as a sound signal of an output video (a video including output frames), and may refer to a voice corresponding to lip shapes of a target object displayed in the output frames.

Similar to the above-described template video, the server 100 may obtain a target voice by receiving the target voice from another device or by loading a stored target voice. For example, the server 100 may obtain a target voice by loading the target voice from the memory 130. However, this is merely an example, and the spirit of the present disclosure is not limited thereto.

In a selective embodiment of the present disclosure, the server 100 may generate a target voice from a text by using a trained second artificial neural network. In this case, the second artificial neural network may refer to a neural network that has been trained (or learned) to output the target voice 580 corresponding to a reading sound of the text 570 as the text 570 is input, as shown in FIG. 9.

Meanwhile, a ‘text’ may be generated by the server 100 according to a certain rule or a certain method. For example, in an example in which the server 100 provides a response according to a request received from the user terminal 200, the server 100 may generate a text corresponding to the responds to the request received from the user terminal 200 by using a third artificial neural network (not shown).

Meanwhile, in an example in which the server 100 provides a response (or a video) according to a pre-set scenario, the server 100 may read a text from a memory. However, this is merely an example, and the spirit of the present disclosure is not limited thereto.

The server 100 according to an embodiment of the present disclosure may transmit a template video obtained in operation S610 and a target voice obtained in operation S620 to the user terminal 200 (operation S630). At this time, in an embodiment of the present disclosure, the user terminal 200 may store the template video and the target voice received in operation S630 (operation S631).

Meanwhile, the template video and the target voice stored in the user terminal 200 may be used to generate and/or output an output video (or output frames) thereafter, and detailed descriptions thereof will be given later.

The server 100 according to an embodiment of the present disclosure may generate a lip image corresponding to a voice for each frame of the template video by using a trained first artificial neural network.

In the present disclosure, an expression like ‘for each frame of a template video’ may mean generating a lip image for each individual frame of a template video. For example, the server 100 according to an embodiment of the present disclosure may generate a lip image corresponding to a voice for a first frame of the template video by using the trained first artificial neural network (operation S641).

As described with reference to FIG. 7, the first artificial neural network may refer to an artificial neural network that is trained (or learns) to output the second lip image 543, which is generated by modifying the first lip image 542 according to a voice, as the voice 531 and the first lip image 542 are input.

In an embodiment of the present disclosure, the server 100 may input a first lip image obtained from a first frame of a template video and a voice obtained in operation S620 to the first artificial neural network and, as an output result corresponding thereto, generate a lip image corresponding to the first frame.

The server 100 according to an embodiment of the present disclosure may generate first lip-sync data (operation S642). In this case, the first lip-sync data may include identification information of a frame (i.e., the first frame) of a template video used for a lip image, the lip image generated in operation S641, and position information of the lip image in the frame (i.e., the first frame) of the template video used for the lip image. To generate such first lip-sync data, the server 100 according to an embodiment of the present disclosure may identify the position of lips in the first frame and generate position information of a lip image based on the identified position.

The server 100 according to an embodiment of the present disclosure may transmit the first lip-sync data generated in operation S642 to the user terminal 200 (operation S643). In this case, the first lip-sync data may include identification information of a frame (i.e., the first frame) of a template video used for a lip image, the lip image generated in operation S641, and position information of the lip image in the frame (i.e., the first frame) of the template video used for the lip image.

After the first lip-sync data is received, the user terminal 200 may read a frame corresponding to frame identification information from a memory with reference to identification information regarding the first frame included in the first lip-sync data (operation S644). In this case, the user terminal 200 may search for and read a frame corresponding to the identification information from the template video stored in operation S631.

Also, the user terminal 200 may generate an output frame by overlapping a lip image included in the first lip-sync data on the frame read in operation S644 based on the position information of the lip image included in the first lip-sync data (operation S645) and display the same (operation S646). Operations S641 to S646 FR1 described above are operations for describing the processing of the server 100 and the user terminal 200 for the first frame, which is one frame.

The server 100 according to an embodiment of the present disclosure may generate the lip-sync data for a plurality of template video frames on a frame-by-frame basis. In this case, the user terminal 200 may receive lip-sync data generated on the frame-by-frame basis and generate output frames for each lip-sync data.

For example, the server 100 and the user terminal 200 may process a second frame in the same manner as the above-stated first frame according to operations S651 to S656 FR2. In this case, the second frame may be a frame that follows the first frame in the template video.

The user terminal 200 according to an embodiment of the present disclosure displays output frames generated according to the above-described process and, at the same time, reproduces the target voice stored in operation S631, thereby providing an output result in which a target object speaks the corresponding voice to a user. In other words, the user terminal 200 provides output frames in which the shape of the lips is changed to the shape of the lips received from the server 100 as a video of a target voice and provides a target voice received from the server 100 as a voice of the target object, thereby providing a natural lip-sync video.

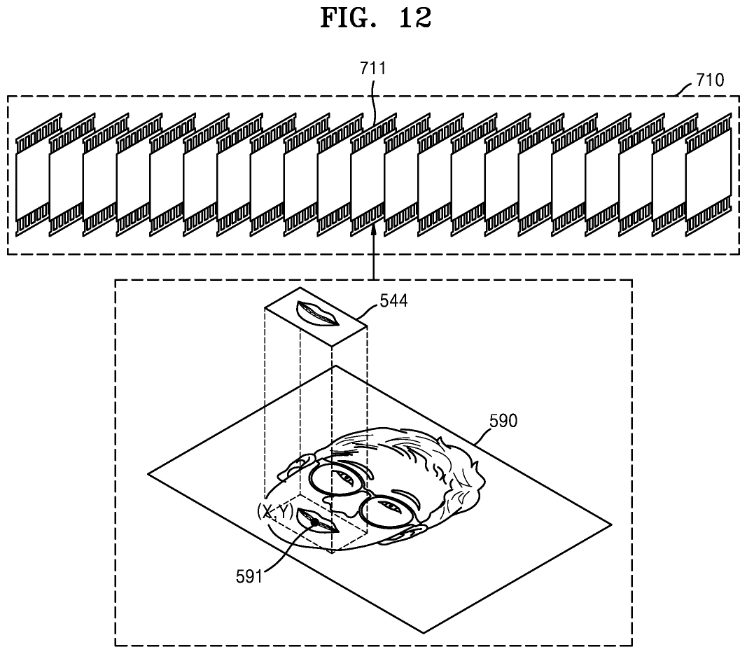

FIG. 12 is a diagram for describing a method by which the user terminal 200 generates output frames according to an embodiment of the present disclosure.

As described above, a template video includes at least one frame, and the server 100 and the user terminal 200 may generate an output frame for each of frames constituting the template video. Accordingly, to the user terminal 200, a set of output frames may correspond to an output video 710.

Meanwhile, in a process of generating individual output frames 711 constituting the output video 710, the user terminal 200 may generate an individual output frame 711 by overlapping the lip image 544 generated by the server 100 on a specific frame 590 of the template video. At this time, the user terminal 200 may determine the overlapping position of the lip image 544 on the specific frame 590 of the template video by using position information 591 regarding a lip image received from the server 100.

Hereinafter, a method of displaying a lip-sync video performed by the user terminal 200 will be described with reference to FIGS. 10 to 11 again.

The user terminal 200 according to an embodiment of the present disclosure may receive a template video and a target voice to be used as the voice of a target object from the server 100 (operation S630) and store the same (operation S631). To this end, the server 100 according to the embodiment may obtain and/or generate the template video and the target voice in advance, as described above in operations S610 to S620.

The user terminal 200 according to an embodiment of the present disclosure may receive lip-sync data generated for each frame. In this case, the lip-sync data may include identification information of frames in a template video, lip images, and position information of the lip images in frames in the template video.

For example, the user terminal 200 may receive first lip-sync data, which is lip-sync data for a first frame (operation S643), and, similarly, may receive second lip-sync data, which is lip-sync data for a second frame (operation S653).

The user terminal 200 according to an embodiment of the present disclosure may display a lip-sync video by using the template video and the target voice received in operation S630 and the lip-sync data received in operations S643 and S653.

For example, the user terminal 200 may read a frame corresponding to frame identification information from a memory with reference to identification information regarding the first frame included in the first lip-sync data received in operation S643 (operation S644). In this case, the user terminal 200 may search for and read a frame corresponding to the identification information from the template video stored in operation S631.

Also, the user terminal 200 may generate an output frame by overlapping a lip image included in the first lip-sync data on the frame read in operation S644 based on position information regarding the lip image included in the first lip-sync data (operation S645) and display the output frame (operation S646).

In a similar manner, the user terminal 200 may display an output frame generated based on second lip-sync data in operation S656.

Of course, the user terminal 200 may generate and display a plurality of output frames in the above-described manner. In other words, the user terminal 200 may receive a plurality of pieces of lip-sync data according to the flow of a target voice and sequentially display output frames generated from the plurality of lip-sync data according to the lapse of time.

The above-described embodiments of the present disclosure described above may be implemented in the form of a computer program that can be executed through various components on a computer, such a computer program may be recorded on a computer readable medium. In this case, the medium may be to store a program executable by a computer. Examples of the medium may include a magnetic medium like a hard disk, a floppy disk, and a magnetic tape, an optical recording medium like a CD-ROM and a DVD, a magneto-optical medium like a floptical disk, a ROM, a RAM, and a flash memory, etc., wherein the medium may be configured to store program instructions.

Meanwhile, the computer program may be specially designed and configured for example embodiments or may be published and available to one of ordinary skill in computer software. Examples of the program may include machine language code such as code generated by a compiler, as well as high-level language code that may be executed by a computer using an interpreter or the like.

The specific implementations described in the present disclosure are merely embodiments and do not limit the scope of the present disclosure in any way. For brevity of the specification, descriptions of conventional electronic components, control systems, software, and other functional aspects of the systems may be omitted. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

Therefore, the spirit of the present disclosure should not be limited to the above-described embodiments, and it is to be appreciated that all changes, equivalents, and substitutes that do not depart from the spirit and technical scope of the present disclosure are encompassed in the present disclosure.

1. A lip-sync video providing apparatus, comprising:
a server comprising a first processor, a memory, a second processor, and a communication unit, wherein the server is configured to:
obtain a template video comprising at least one frame and depicting a target object,
obtain a target voice to be used as a voice of the target object,
generate a lip image corresponding to the voice for each frame of the template video by using a trained first artificial neural network, and
generate lip-sync data comprising frame identification information of a frame in the template video, the lip image, and position information regarding the lip image in a frame in the template video;
wherein:
the first processor is configured to control a series of processes of generating output data from input data by using the trained first artificial neural network; and
the second processor is configured to perform an operation under the control of the first processor;
a service server in communication with the server and operable to receive the lip-sync data including the generated lip images from the server, generate output frames by using the lip-sync data, and provide the output frames to another device including the user terminal;
wherein the communication unit includes hardware and software that enable the server to communicate with a user terminal and a service server, via a communication network.

2. The lip-sync video providing apparatus of claim 1, wherein the user terminal is operable to receive the lip-sync data.

3. The lip-sync video providing apparatus of claim 2,
wherein the user terminal is further configured to:
read a frame corresponding to the frame identification information from a memory with reference to the frame identification information, and,
based on the position information regarding the lip image, generate an output frame by overlapping the lip image on a read frame.

4. The lip-sync video providing apparatus of claim 3, wherein the server is further configured to:
generate the lip-sync data for each frame of the template video, and
wherein the user terminal is further configured to:
receive the lip-sync data generated for each frame and generates an output frame for each of the lip-sync data.

5. The lip-sync video providing apparatus of claim 2, wherein, before transmitting the lip-sync data to the user terminal, the server is further operable to transmit at least one of identification information of the template video, the template video, and the voice to the user terminal.

6. The lip-sync video providing apparatus of claim 1, wherein the first artificial neural network comprises an artificial neural network trained to output a second lip image,
the second lip image generated based on modification of the first lip image according to a voice, as the voice and the first lip image are input.

7. The lip-sync video providing apparatus of claim 1,
wherein the server is further configured to generate the target voice from a text by using a trained second artificial neural network, and
the second artificial neural network is an artificial neural network trained to output a voice corresponding to an input text as a text is input.

8. A lip-sync video providing apparatus comprising:
a server comprising:
at least one processor;
a memory coupled to the at least one processor;
a communication unit coupled to the at least one processor,
wherein the server is configured to:
receive a template video and a target voice to be used as a voice of a target object from a server;
receive lip-sync data generated for each frame, wherein the lip-sync data comprises frame identification information of a frame in the template video, a lip image, and position information regarding the lip image in a frame in the template video; and
display a lip-sync video by using the template video, the target voice, and the lip-sync data;
wherein the communication unit includes hardware and software that enable the server to communicate with a user terminal, a service server, via a communication network; and
a service server in communication with the server and operable to receive the lip-sync data including the generated lip images from the server, generate output frames by using the lip-sync data, and provide the output frames to another device including the user terminal.

9. The lip-sync video displaying apparatus of claim 8,
wherein the server is further configured to:
read a frame corresponding to the frame identification information from a memory with reference to the frame identification information included in the lip-sync data,
generate an output frame by overlapping the lip image included in the lip-sync data on a read frame based on the position information regarding the lip image included in the lip-sync data, and
display a generated output frame.

10. The lip-sync video displaying apparatus of claim 9, wherein the server is further configured to:
receive a plurality of lip-sync data according to a flow of the target voice, and
sequentially display output frames respectively generated from the plurality of lip-sync data according to the lapse of time.

11. A lip-sync video providing method comprising:
obtaining a template video comprising at least one frame and depicting a target object;
obtaining a target voice to be used as a voice of the target object;
generating a lip image corresponding to the target voice for each frame of the template video by using a trained first artificial neural network;
generating lip-sync data comprising frame identification information of a frame in the template video, the lip image, and position information regarding the lip image in a frame in the template video; and
providing a video in which a voice and lip shapes are synchronized.

12. The lip-sync video providing method of claim 11, further comprising transmitting the lip-sync data to a user terminal.

13. The lip-sync video providing method of claim 12, comprising:
at the user terminal, reading a frame corresponding to the frame identification information from a memory with reference to the frame identification information; and
based on the position information regarding the lip image, generating an output frame by overlapping the lip image on a read frame.

14. The lip-sync video providing method of claim 13, further comprising:
generating the lip-sync data for each frame of the template video;
at the user terminal, receiving the lip-sync data generated for each frame; and
generating an output frame for each of the lip-sync data.

15. The lip-sync video providing method of claim 12, wherein, before transmitting the lip-sync data to the user terminal, transmitting at least one of identification information of the template video, the template video, and the voice to the user terminal.

16. The lip-sync video providing method of claim 11, wherein the first artificial neural network is an artificial neural network trained to output a second lip image, which is generated by modifying the first lip image according to a voice, as the voice and the first lip image are input.

17. The lip-sync video providing method of claim 11, further comprising:
generating the target voice from a text by using a trained second artificial neural network;
wherein the second artificial neural network is an artificial neural network trained to output a voice corresponding to an input text as a text is input.
